(19) United States
(12) Patent Application Publication
(10) Pub. No.: US 2026/0120584 A1
(43) Pub. Date: Apr. 30, 2026

(54) System and method for generating integrated progressively complex rhythmic-coordinative cognitive-motor movements to strengthen cognition

(71) Applicant: Move2Learn LLC, New Haven, CT (US)

(72) Inventors: Lynne M. Kenney, Cave Creek, AZ (US); Benjamin S. Bunney, Branford, CT (US)

(73) Assignee: Move2Learn LLC, New Haven, CT (US)

(21) Appl. No.: 18/930,610

(22) Filed: Oct. 29, 2024

(51) Int. Cl. G09B 5/06

(52) U.S. Cl. CPC G09B 5/06

(57) ABSTRACT

A system and method which integrate cognitive science, kinesiology, auditory neuroscience, developmental psychology, and occupational therapy to build a program of progressively complex rhythmic-coordinative cognitive-motor movements designed to engage the foundational motor and cognitive skills that precede learning. Multiple levels of progressively complex motor movements that introduce motor skills are presented in a specific developmental order. The levels progress through systematic cognitive and motor patterns with increasing complexity. Each level progresses to higher complexity that requires mastery of the previous levels. The complexity grows through increasing the cognitive processing requirements, increasing the sensory-motor processing demands and increasing the complexity of the movements.

### FIELD OF THE INVENTION

The present invention generally relates to the fields of cognitive science, embodied cognition, and motor skills, and more specifically to the field of integrating cognitive and motor skills development.

### BACKGROUND OF THE INVENTION

The relationship between sensory-motor skills (balance, core strength, awareness of the body in space), fundamental motor skills (catch, throw, kick, walk, run, jump), and executive function (higher order thinking and control mechanisms like self-regulation, attention, memory, response inhibition, cognitive flexibility) has garnered increased attention and research. Studies have shown a strong connection between the parts of the brain involved in motor (movement) skills (primarily the cerebellum) and cognitive (thinking) skills (primarily the prefrontal cortex) across the human lifespan. These studies include Flores et al., 2023, Relationships between Math Skills, Motor Skills, Physical Activity, and Obesity in Typically Developing Preschool Children. Behavioral Sciences, the contents of which are incorporated by reference herein in its entirety.

### Sensory-Motor Skills

The ability to develop fundamental motor skills is predicated upon the presence of sensory-motor skills. Sensory-motor skills begin development in utero and form the precursor skills and abilities necessary for motor coordination and goal-oriented movement. Sensory-motor skills use sensory perception and sensory feedback to facilitate vestibular, proprioceptive, visual, auditory, fine, and gross motor function.

The Nervous System includes the brain, spinal cord, and a complex network of nerves. The nervous system is the major controlling, regulatory, and communicating system in the body. The musculoskeletal system is made up of bones, ligaments, tendons, cartilage and muscle. The musculoskeletal system gives the body its basic structure, posture, and the ability to move.

Motor coordination/Motor competency is the ability to plan and execute smooth, accurate, and controlled motor movements in response to a stimulus. That stimulus can be an internal thought (lift your arm) or an external stimulus (catch a ball coming toward you). Cognition is the mental action or process of acquiring knowledge and understanding through thought, experience, and the senses.

Executive function describes a set of cognitive processes and mental skills that help an individual plan, monitor, and successfully execute goal-oriented actions.

Academic Achievement represents performance outcomes that indicate the extent to which a person has accomplished specific goals that were the focus of activities in instructional environments, specifically in school, college, and university.

The Somatosensory Cortex is the region of the brain which processes sensory information from touch, proprioception (awareness of body position), and kinesthetic feedback (awareness of movement). The somatosensory cortex integrates sensory inputs to guide precise motor actions. The Motor Cortex and Premotor Cortex are the regions of the brain which work in coordination with the somatosensory cortex to execute precise movements based on sensory feedback. The integration of sensory information with motor commands allows for accurate, fluid, and controlled actions.

The Basal Ganglia and the Cerebellum are the brain structures which play central roles in refining and coordinating motor movements. The basal ganglia, motor cortex, and cerebellum receive and respond to sensory inputs while contributing to motor learning and coordination.

Ipsilateral refers to movement which occurs on one side of the body, as an example, the right hand taps the right hip.

Bilateral refers to movement which occurs on two sides of the body, as an example, both arms are lifted in a flex position.

Contralateral refers to movement which occurs on opposite sides of the body, as an example, the right elbow reaches across the body to touch the knee on the left leg.

Coronal Plane refers to a vertical plane dividing the dorsal (back) and ventral (front) planes of the body. Dorsal refers to the back portion of the body. Ventral refers to the front part of the body. Sagittal Plane refers to a vertical plane that divides the body or any of its parts into right and left sides. Transverse Plane refers to a horizontal plane that divides the body or any of its parts into upper and lower parts.

Sensory-motor skills include skills related to muscle tone, strength, balance, and coordination. They are subdivided into fine and gross motor skills, vestibular strength (balance and posture), visual tracking and visual coordination, rhythm, tempo and timing, and motor coordination. Sensory-motor skills are considered developmentally foundational as they are needed to support movement, including locomotor (moving the whole body through space, e.g., walking) and fine motor skills (e.g., writing, eating with a fork and knife), balance, weight shift (e.g., shifting your weight from one leg to the other), and core strength (required for posture, balance and movement in space).

Sensory-motor skills are essential for activities of daily life (e.g., buttoning clothing, making a bed, reaching for a plate in a cupboard) and for academic tasks (e.g., holding a sheet of paper with one hand while one writes with the opposite hand; remaining upright and seated in a chair while reading or writing; looking up at a whiteboard and then down again at one's paper to read, write or complete math problems). Deficits in core strength, ability to shift weight from one side of the body to the other, balance, maintaining posture and efficiently moving the body in space can interfere with learning and behavior.

Sensory-motor skills facilitate motor coordination of the limbs in ipsilateral (single side of the body), bilateral (both sides of the body), and rotational ability (movement of the trunk and limbs around the central axis of the body). Ipsilateral, bilateral, and rotational coordination are necessary for efficient goal-directed tasks of everyday living (e.g., writing, reading, tying shoes, throwing, swinging, running, climbing). Motor coordination requires harmonization of the nervous and musculoskeletal systems, resulting in rapid, fluid, accurate, balanced, and automated motor responses. Motor coordination is correlated with cognition, executive function, and academic achievement, as discussed in the following references: Fernandes et al., 2016, Motor Coordination Correlates with Academic Achievement and Cognitive Function in Children, Frontiers in Psychology; Oberer et al., 2018, Executive functions, visual-motor coordination, physical fitness and academic achievement: Longitudinal relations in typically developing children, Hum. Mov. Sci.; van der Fels et al., 2015, The relationship between motor skills and cognitive skills in 4-16 year old typically developing children: A systematic review, J. Sci. Med. Sport, the contents of which are incorporated by reference herein in their entirety.

### Fundamental Motor Skills

Fundamental motor skills are the building blocks of physical activity, including catching, throwing, walking, running, and jumping. These skills are utilized to attain health and cognition throughout the lifespan. Under circumstances where there are deficits in fundamental motor skills, executive function may be diminished, as discussed in Bhat et al., 2021, Motor Impairment Increases in Children With Autism Spectrum Disorder as a Function of Social Communication, Cognitive and Functional Impairment, Repetitive Behavior Severity, and Comorbid Diagnoses: A SPARK Study Report. Autism research: official journal of the International Society for Autism Research; Lachambre et al., 2021, Attentional and executive functions in children and adolescents with developmental coordination disorder and the influence of comorbid disorders: A systematic review of the literature. PloS One, the contents of which are incorporated by reference herein in their entirety.

Fundamental motor skill acquisition is strongly associated with neuromotor, cognitive, social, and emotional development, as discussed in Battaglia et al., 2019, The Development of Motor and Pre-literacy Skills by a Physical Education Program in Preschool Children: A Non-randomized Pilot Trial, Frontiers in Psychology, the contents of which are incorporated by reference herein in its entirety. Motor skill learning and training is accompanied by improved cognitive benefits in children and adolescents, as discussed in Shi & Feng, 2022, Motor skills and cognitive benefits in children and adolescents: Relationship, mechanism and perspectives, Frontiers in Psychology, the contents of which are incorporated by reference herein in its entirety.

### Relationship Between Fundamental Motor Skills and Sensory-Motor Skills

Fundamental motor skills and sensory-motor skills are closely related. While distinct brain regions specialize in different aspects of motor control (e.g., somatosensory cortex, premotor cortex, cerebellum) they work together to execute complex movements, as discussed in Miall, 2021, Cortical Motor Control. In: Neuroscience in the 21st Century, the contents of which are incorporated by reference herein in its entirety. The integration of sensory information with motor commands occurs in both fine and gross motor skills and sensory-motor skills to achieve coordinated and purposeful actions. Without well-developed sensory-motor skills, fundamental motor skills may not proficiently develop, as discussed in Libertus & Hauf, 2017, Editorial: Motor Skills and Their Foundational Role for Perceptual, Social, and Cognitive Development. Frontiers in Psychology, the contents of which are incorporated by reference herein in its entirety.

Fundamental motor skills are supported by sensory-motor skills and include sitting, standing, walking, running, jumping, kicking, reaching, catching, throwing, and hitting. As one develops from infancy to adulthood, fundamental motor skills generally develop in a stepwise progression. As an example, a toddler can walk, then run, before they can skip. A first grader can hold a pencil before they can snap their fingers. A child can catch large objects such as a playground ball with both hands before they can catch smaller objects like a tennis ball with one hand. All of these motor skills require intact sensory-motor skills including balance, visual tracking, vestibular strength, fine motor, and gross motor coordination.

Fundamental motor skills also require learning how to coordinate movements across several planes of the body. FIGS. 1-4 illustrate ipsilateral, bilateral, and contralateral relationships in the body. These movements occur within and between the three planes of the body, referred to in kinesiology and occupational therapy as (1) the coronal or frontal plane, (2) the sagittal plane, and (3) the transverse plane. The coronal or frontal plane divides the body into front (ventral) and back (dorsal) regions. The sagittal plane divides the body into left and right regions at the midline of the body. The transverse plane divides the body into upper and lower regions.

The ability to move with increasing fluidity and motor competency across the planes of the body requires motor control and coordination. Motor competency also progresses in a developmental sequence. For example, humans can move limbs on one side of their body (e.g., reach for a cup) before they can meet their limbs at the midline of their body (e.g., clap). They can meet at the midline of their body before they can cross the midline of their body (e.g., reach to the left with the right hand). They can lift their knees in front of them before they can cross their knees or feet behind their body.

### Motor Skills and Academic Achievement

Motor skill proficiency has been shown to be correlated with academic, social, and emotional competency. Children with higher levels of motor proficiency are better able to interact with elements of the world around them. Children with better fine motor skills have been shown to have higher levels of emergent literacy and numeracy skills, as discussed in Cinar et al., 2023, Motor Skills are More Strongly Associated to Academic Performance for Girls Than Boys, Canadian Journal of School Psychology, the contents of which are incorporated by reference herein in its entirety. Motor skills of children in kindergarten correlate with social interaction and predict social-emotional adjustment and scholastic adaptation in first grade, as discussed in Bart et al., 2007, Predicting school adjustment from motor abilities in kindergarten. Infant Child Dev.; Holloway & Long, 2019, The Interdependence of Motor and Social Skill Development: Influence on Participation. Physical therapy, the contents of which are incorporated by reference herein in its entirety. Well-developed motor skills are associated with better social functioning, mental health, and self-confidence in children and adolescents, as discussed in Mancini et al., 2016, The Relationship between Motor Skills, Perceived Social Support, and Internalizing Problems in a Community Adolescent Sample. Frontiers in psychology, the contents of which are incorporated by reference herein in its entirety. Poor motor development may impact social functioning through at least two routes: first by limiting the potential to participate in physical activities and play, and second by affecting executive control and social understanding, as discussed in Leonard, 2016, The Impact of Poor Motor Skills on Perceptual, Social and Cognitive Development: The Case of Developmental Coordination Disorder. Frontiers in psychology, the contents of which are incorporated by reference herein in its entirety.

### Cognition

Cognition refers to the mental action or process of acquiring knowledge and understanding through thought, experience, and the senses. Generally speaking, cognition includes the ability to think. Cognition spans a broad range of information processing skills needed for memory, learning, communication, and problem-solving, as discussed in Zelazo et al. 2021, Measurement of Cognition for the National Children's Study. Frontiers in Pediatrics, the contents of which are incorporated by reference herein in its entirety. Executive function is a part of human cognition. Executive function refers to the cognitive processes that are required for the conscious, intentional control of action, thought, and emotions. Individual differences in executive function skills predict important developmental outcomes, including educational achievement, innovation, and job success, as discussed in Zelazo et al. 2021.

Executive Function may include three core cognitive competencies: inhibitory control (resisting temptations and not acting impulsively), working memory (storing information in mind and using it creatively), and cognitive flexibility (shifting thoughts or strategies for a problem to adapt flexibly to new demands, rules, or priorities), as discussed in Miyake et al. 2000, The unity and diversity of executive functions and their contributions to complex “frontal lobe” tasks: A latent variable analysis. Cogn. Psychol.; Diamond, 2013, Executive functions. Annu. Rev. Psychol., the contents of which are incorporated by reference herein in its entirety.

Recent research has shown that motor skills have been associated with each of the three components of executive function. For example, balance and postural control require sustained attention. Pattern recognition and sequencing (putting things in order) require visual scanning (looking at the surrounding area), visual tracking (keeping track of things that move through the area), attention, and working memory. Fine motor skills show a relationship with visual processing more broadly. Bilateral body coordination shows a strong relationship with fluid intelligence (ability to use available information flexibly, e.g., to solve a problem or identify a pattern), as discussed in van der Fels et al., 2015.

### Physical Activity to Strengthen Motor and Cognitive Skills

Physical activity has been shown to enhance motor and cognitive development by improving physical health, social well-being, cognition, and academic achievement in children, adolescents, and adults, as discussed in Festa et al., 2023, Move Your Body, Boost Your Brain: The Positive Impact of Physical Activity on Cognition across All Age Groups. Biomedicines; Haverkamp et al., 2021, Physical fitness, cognitive functioning and academic achievement in healthy adolescents. Psychology of Sport and Exercise, the contents of which are incorporated by reference herein in its entirety. Physical activity that also requires use of executive function can improve the structural plasticity of gray matter and white matter in the brain, improve brain structure and functional networks, and strengthen executive function in children and adolescents, as discussed in Shi & Feng, 2022. It is believed that cognitively engaging physical activities activate the same frontal-dependent neural networks that are activated when executive function skills are activated. Increased activation of these brain networks after a bout of physical activity may result in more efficient neural functioning during subsequent cognitive activities, resulting in improved performance, as discussed in Song et al., 2022, Play Smart, Be Smart? Effect of Cognitively Engaging Physical Activity Interventions on Executive Function among Children 4˜12 Years Old: A Systematic Review and Meta-Analysis. Brain sciences, p. 11, the contents of which are incorporated by reference herein in its entirety.

Initial efforts have been made to use this new understanding. Most of these efforts are physical education programs that add cognitive elements (e.g., rules to follow, quickly changing tasks), however, they do not specifically target executive function skills. Targeting executive function skills requires progressively increasing cognitively demanding tasks to accompany the physical activity as skill competency grows. Although there have been initial studies investigating the effects of cognitive and physical tasks, this research was not specifically designed to target specific cognitive skills. This research investigated the effects of cognitively and physically demanding games versus only cognitively demanding games versus a control group, as discussed in Egger et al. 2019, Boost your brain, while having a break! The effects of long-term cognitively engaging physical activity breaks on children's executive functions and academic achievement. PloS One and Schmidt et al. 2020, Disentangling the relationship between children's motor ability, executive function and academic achievement. PLOS One, the contents of which are incorporated by reference herein in their entirety. The cognitively and physically demanding groups performed games similar to standard pre-school and early school years games, such as Simon Says or the Hokey Pokey, that require gross motor movements, often including whole body movements. They increased the cognitive demands over time by varying instructions and activities based on guidelines; however, these increased cognitive demands were not specifically designed to target specific cognitive skills. The activities were completed in 3-15 minute sessions, every school day.

A separate area of research has shown that there is a notable connection between rhythm and beat competency (being able to move to the beat of music) with motor skills generally and with cognition, including language, as discussed in Nitin et al., 2023, Exploring individual differences in musical rhythm and grammar skills in school-aged children with typically developing language, Scientific Reports; Oberer et al., 2018; Särkämö et al., 2013, Music perception and cognition: development, neural basis, and rehabilitative use of music, WIREs Cognitive Science; Tierney & Kraus, 2013, The ability to tap to a beat relates to cognitive, linguistic, and perceptual skills, Brain and Language, the contents of which are incorporated by reference herein in their entirety. Deficits in rhythm and beat saliency have also been reported in children with developmental diagnoses and learning disabilities.

Rhythmic training has also been associated with the development of executive function skills. These skills may support academic achievement as they help children organize their thoughts, manage tasks, and stay focused. Implementing a rhythm and movement intervention has also been shown to help preschool children to improve their self-regulation abilities, as discussed in Williams & Berthelsen, 2019, Implementation of a rhythm and movement intervention to support self-regulation skills of preschool-aged children in disadvantaged communities, Psychology of Music, the contents of which are incorporated by reference herein in its entirety. The rhythm and movement intervention used include both physical activity performed to music and exercises that are related to executive function skills. However, there is no discussion which ties specific movements to specific executive function and cognition skills.

Rhythm skills and beat competency have been shown to have a significant influence on reading and writing acquisition, as discussed in David et al., 2007, Rhythm and reading development in school-age children: a longitudinal study, Journal of Research in Reading; Lundetræ & Thomson, 2018, Rhythm production at school entry as a predictor of poor reading and spelling at the end of first grade, Reading and Writing; Ozernov-Palchik et al., 2018, Musical rhythm and reading development: does beat processing matter?, Annals of the New York Academy of Sciences, the contents of which are incorporated by reference herein in its entirety. While these relationships have been found, current programs do not directly combine reading skills (e.g., visual scanning and tracking) with the movement and cognition skills.

### Breath Control to Support Mental and Physical Functions

Slow deep breathing is a simple yet powerful technique that is used to promote relaxation and reduce stress. This practice involves taking slow, deep breaths to fill the lungs completely, followed by a slow exhalation. Numerous studies have demonstrated the significant calming effects of this breathing method, making it a valuable tool for enhancing mental and physical well-being.

One of the primary benefits of slow deep breathing is its ability to activate the parasympathetic nervous system, which is the system of the body that is responsible for promoting a state of calm and relaxation. When a person engages in slow deep breathing, the vagus nerve is stimulated, which leads to a decrease in heart rate and blood pressure. This physiological response helps to counteract the effects of the sympathetic nervous system, which is the system of the body activated during stress and anxiety, as discussed in Jerath et al., 2006, Physiology of long pranayamic breathing: neural respiratory elements may provide a mechanism that explains how slow deep breathing shifts the autonomic nervous system. Medical Hypotheses, the contents of which are incorporated by reference herein in its entirety.

Additionally, slow deep breathing has been shown to reduce levels of cortisol, the body's primary stress hormone. High levels of cortisol are associated with various health issues, including anxiety, depression, and impaired cognitive function. By reducing cortisol levels, slow deep breathing helps to alleviate these negative effects, leading to improved mental health and emotional well-being, as discussed in Perciavalle et al., 2017, The role of deep breathing on stress. Neurological Sciences, the contents of which are incorporated by reference herein in its entirety.

Moreover, slow deep breathing can enhance mindfulness and present-moment awareness. This practice encourages individuals to focus on their breath, which can serve as an anchor to the present moment. This focus on the breath helps to quiet the mind and reduce the intrusion of negative thoughts and worries, fostering a sense of inner peace and calm, as discussed in Zeidan et al., 2010, Mindfulness meditation improves cognition: Evidence of brief mental training. Consciousness and Cognition, the contents of which are incorporated by reference herein in its entirety.

The calming effects of slow deep breathing also extend to physical well-being. For instance, regular practice of slow deep breathing has been linked to improved lung function and increased oxygen saturation in the blood. This can lead to enhanced physical performance and endurance, as well as a general feeling of vitality, as discussed in Martarelli et al., 2011, Diaphragmatic breathing reduces exercise-induced oxidative stress. Evidence-Based Complementary and Alternative Medicine, the contents of which are incorporated by reference herein in its entirety.

Furthermore, slow deep breathing can improve sleep quality by promoting relaxation and reducing the hyperarousal state often associated with insomnia. By calming the mind and body before bedtime, individuals can fall asleep more easily and enjoy deeper, more restorative sleep, as discussed in Khalsa et al., 2009, Yoga ameliorates performance anxiety and mood disturbance in young professional musicians. Applied Psychophysiology and Biofeedback, the contents of which are incorporated by reference herein in its entirety.

The practice of slow deep breathing offers a multitude of calming effects that benefit both mental and physical health. By activating the parasympathetic nervous system, reducing cortisol levels, enhancing mindfulness, improving lung function, and promoting better sleep, slow deep breathing stands as a powerful and accessible tool for fostering overall well-being. Its simplicity and effectiveness make it an invaluable practice for anyone seeking to manage stress and enhance their quality of life.

### SUMMARY OF THE INVENTION

The present disclosure describes a system and method which in an embodiment integrate cognitive science, kinesiology, auditory neuroscience, developmental psychology, and occupational therapy to build a program of progressively complex rhythmic-coordinative cognitive-motor movements designed to engage the foundational motor and cognitive skills that precede learning.

In an embodiment, the present invention includes an audio, visual, or audiovisual sequence of multiple levels of progressively complex motor movements that introduce motor skills presented in a specific developmental order. The levels progress through systematic cognitive and motor patterns with increasing complexity. Each level progresses to higher complexity that requires mastery of the previous levels. The complexity grows through increasing the cognitive processing requirements, increasing the sensory-motor processing demands (coordinating what is seen, heard, and felt with how the body is moving) and increasing the complexity of the movements.

The progression of movements is tied to developing fundamental motor skills. In an embodiment, the present disclosure establishes a system and method of an audio, visual, or audiovisual sequence having a unique set of planar-spatial zones of movement and uses these zones to gradually increase the complexity of the movements. In an embodiment, the present disclosure begins with vertical patterns and sequences, then gradually progresses to crossing the coronal, sagittal and transverse planes into an increasing number of the planar-spatial zones, requiring coordinative whole body movements in time with the music. The movements start at relatively easy and simple unilateral and bilateral movements (e.g., moving the right arm or clapping at the center of the body). The movements progress to move through increasingly greater areas of the three planes of the body (e.g., stepping forward and backward, rotating the arm like throwing a lasso).

In an embodiment, the present disclosure includes movements that are all performed in 4/4 time to a musical beat. In each movement, one or more parts of the body is moving in time to specific rhythms (temporal patterns in music created by the onsets and durations of the acoustic elements). The rhythm of beats remains consistent, but movements can occur on a subset of beats (e.g., on beats 2 and 4), on all the beats, include multiple movements in one beat (e.g. double clap), or across beats (e.g. hold a position for 2 beats). Completing the movements on the correct beats requires auditory processing (listening). With more complex movements, the auditory processing demands increase. Increasing auditory processing demands are one example of how the sensory-motor processing demands increase.

In an embodiment, the instructions for which movements to complete on each beat are delivered through audio and visual formats in time with the music. The current and upcoming movements are also conveyed using a cognitive-motor-visual code. The code uses symbols and colors to refer to each movement and shows the moves in sequence with one line referring to one measure in the music (e.g., 4 beats in music with a 4/4 time signature). This code is read from left to right and from top to bottom, like reading in English. The code reinforces the skills needed for reading English and ties those skills to the cognitive, sensory-motor, and rhythmic-coordinative skills.

In an embodiment, the present disclosure is designed to be used every day in 5 minute sessions done 2-3 times for a total of about 15 minutes. These sessions may be conducted for participants of all ages. In certain applications, it may be productive to group people based on age and conduct the sequences and training to groups of individuals of roughly a similar age. This may be more a factor when presenting to younger individuals.

In an embodiment, the present disclosure includes deep breathing exercises that are optionally completed at the end of each 5 minute session. The deep breathing exercises instruct participants on breathing slowly and deeply and may help participants to return to a calm, alert state.

### DESCRIPTION OF DRAWINGS

FIG. 1 is an illustration of ipsilateral body plane and movement;

FIG. 2 is an illustration of upper bilateral body plane and movement;

FIG. 3 is an illustration of lower bilateral body plane and movement;

FIG. 4 is an illustration of contralateral body plane and movement;

FIG. 5 is an illustration of the coronal planar-spatial zones of movement;

FIG. 6 is an illustration of the left sagittal planar-spatial zones of movement;

FIG. 7 is an illustration of the right sagittal planar-spatial zone of movement;

FIG. 8 is an illustration of the transverse planar-spatial zones of movement;

FIG. 9 is an illustration of contralateral movement;

FIG. 10 is an illustration of an example of the user interface/display at two different difficulty levels;

FIG. 11 is an illustration of an example of the user interface/display at level five including a half note (two beats) movement as well as quarter note movements;

FIG. 12 is an illustration of an example of the user interface/display at level five with quarter note movements on every beat and changing movement patterns from one line to the next;

FIG. 13 is an illustration of an example of the user interface/display with a movement on beat four;

FIG. 14 is an illustration of an example of the user interface/display at the first level; and

FIG. 15 is a block diagram of a system for implementing an embodiment of the present invention.

### DETAILED DESCRIPTION OF THE INVENTION

In an exemplary embodiment, an implementation of the invention includes an audio, visual, or audiovisual sequence of 9 levels that progressively build in complexity. Each level may have 5 options that are each 5 minutes long. Each option includes a Priming portion of 32 beats to practice previous moves, New Move 1 that introduces a new move over 32 beats, a practice of the new move for 32 beats, a cognitive-movement break for 16 beats, New Move 2 for 32 beats, practice new move 2 for 32 beats, another cognitive-movement break for 16 beats, and 2 performances putting all moves together for 64 beats each. Complexity is increased by changing the movements, how the movements line up with the music, and the cognitive and motor skills required to successfully complete the movement sequences.

In an embodiment, the present invention also may include an optional presentation or sequence of activities designed to incorporate the beneficial effects of breathing, presented after each session. The breathing activities do not change in difficulty. They are presented to provide an opportunity for participants to return to a calm, alert state after the movement activities.

The sessions are completed in a group setting, such as a school classroom. The group completes one session at a time. The group is ready to move to the next level once a sufficient level, e.g., 80%, of the group is able to complete the correct movements on the beat. Alternatively, the sessions may be completed for a single individual. In such an individual setting, the individual is ready to move to the next level once the individual is able to complete a sufficient amount of the movements correctly, e.g., a majority of movements or 80% of the movements, or a similar level.

FIG. 15 is a block diagram of a system 1500 for implementing an embodiment of the present invention. As shown in FIG. 15, system 1500 includes a processor 1510 which communicates with a memory 1520. The memory 1520 may include instructions for execution by the processor 1510, as well as being used to store other information of the system 1500, such as various audio and/or visual information. The processor 1510 communicates with a display 1540 and optionally a speaker 1550 for providing visual and/or audio information to a user. In addition, the processor 1510 communicates with a user input device 1530 for allowing the user to provide inputs or selections to the system 1500. The user interface (e.g., audio, visual, or audiovisual sequence) provides cues for which movements to complete.

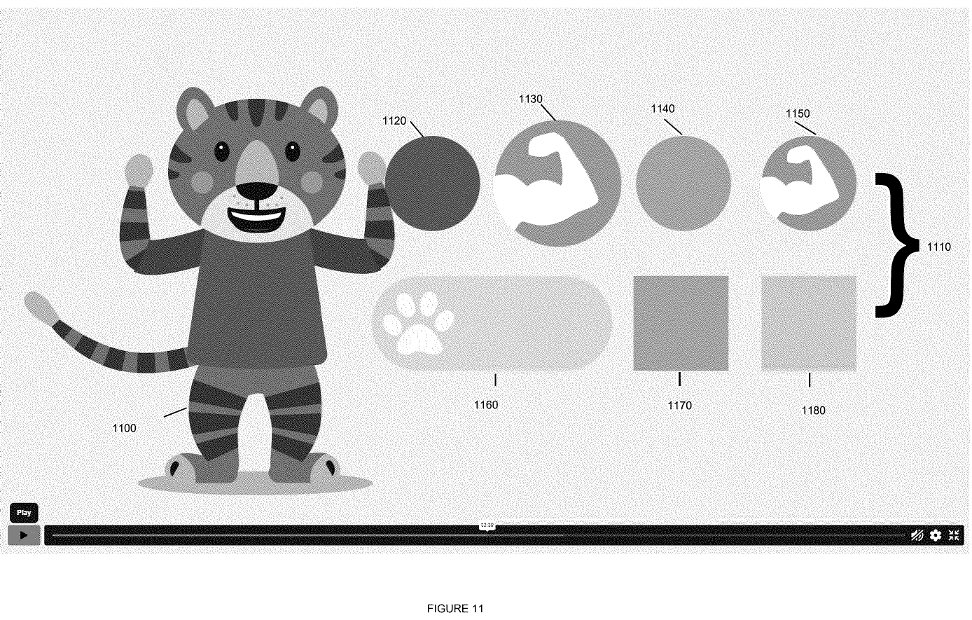

FIG. 10 shows an example of the user interface at two different difficulty levels. The user interface includes three key features. First, on the left is a character 1000 who demonstrates each movement in time to the beat. For the initial levels, the character 1000 also provides auditory cues for each movement. Second, on the right is the cognitive-motor-visual code 1010. The cognitive-motor-visual code creates the conditions for combining cognitive processing and physical activity. The code 1010 includes 4 symbol positions per line, 1020, 1030, 1040, and 1050, corresponding to the 4 beats of each measure of the music. Unique symbols, having a shape and/or a color, are used for each position or movement (e.g., a red circle for clap). Alternatively, different shading or hatching may be used to denote different symbols instead of using different colors. Symbols may take up more than one position to indicate completing the movement over multiple beats (e.g., hold a movement for two beats). Some positions of the visual code may not require any movement, but may alternatively require that the user just count along with the beat. Such a “count to the beat” may be illustrated using just a number, instead of a graphical symbol corresponding to a movement. Third, the user interface shows two lines of code at a time, enabling anticipation of upcoming movements. Anticipation of movements is necessary to complete the movement on the beat without a delay. The code reads from left to right and top to bottom, like written English. As the presentation of the visual code sequences along the four symbol positions, each symbol may be slightly enlarged momentarily to make it stand out from the remaining symbols of the line. Alternatively, a single line of code or more than two lines of code may be shown at the same time.

In the specific example of visual code 1010 presented in FIG. 10, the first and third positions 1020 and 1040 require just a “count to the beat”, while the second and fourth symbols 1030 and 1050 require a particular movement.

Similar to FIG. 10, FIG. 11 is an illustration of an example of the user interface/display which includes a character 1100 who demonstrates each movement in time to the beat. For the initial levels, the character 1100 also provides auditory cues for each movement. Second, on the right is the cognitive-motor-visual code 1110. The visual code 1110 includes four symbol positions on the first line, 1120, 1130, 1140, and 1150, corresponding to the four beats of each measure of the music. Unique symbols, having a shape and/or a color, are used for each movement. In the specific example of visual code 1110 shown in FIG. 11, the visual code 1110 may include different movements in the first and third position 1120 and 1140. The second and fourth positions 1130 and 1150 may be the same movement as depicted by the same graphical symbol. The second line of the code includes symbol 1160 which takes up more than one position to indicate completing the movement over multiple beats (e.g., hold a movement for two beats or a half note). The remainder of the second line of visual code 1110 may include different movements 1170 and 1180 as depicted by different color or different shading.

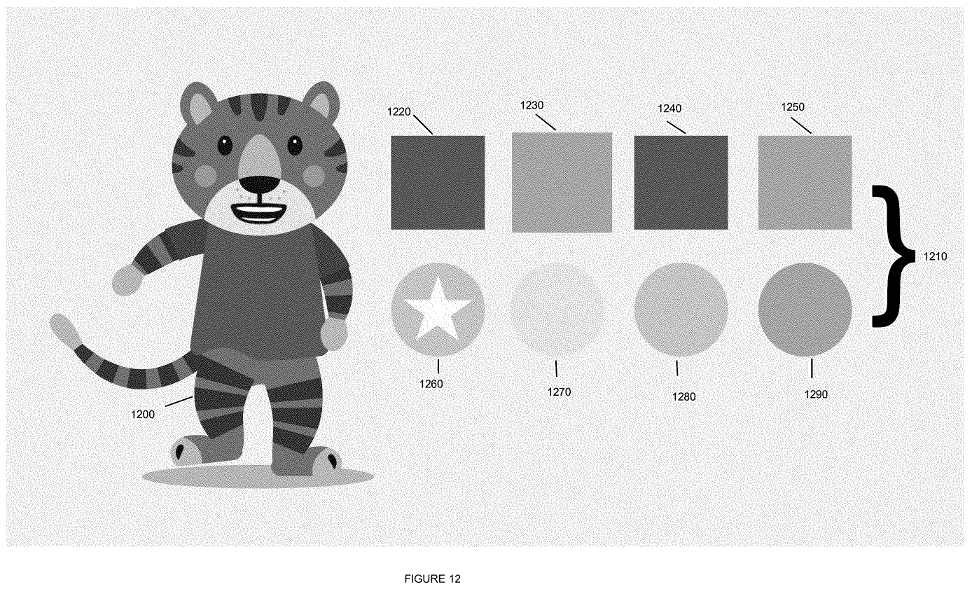

Similar to FIGS. 10 and 11, FIG. 12 is an illustration of an example of the user interface/display with two different movements repeated on the first line. Specifically symbols 1220 and 1240 are the same and depict the same movement, while symbols 1230 and 1250 are the same and depict the same movement. On the second line of visual code 1210, an initial movement 1260 (e.g., requiring moving to a hands outstretched or “star” pose) is followed by three different movements 1270, 1280, and 1290.

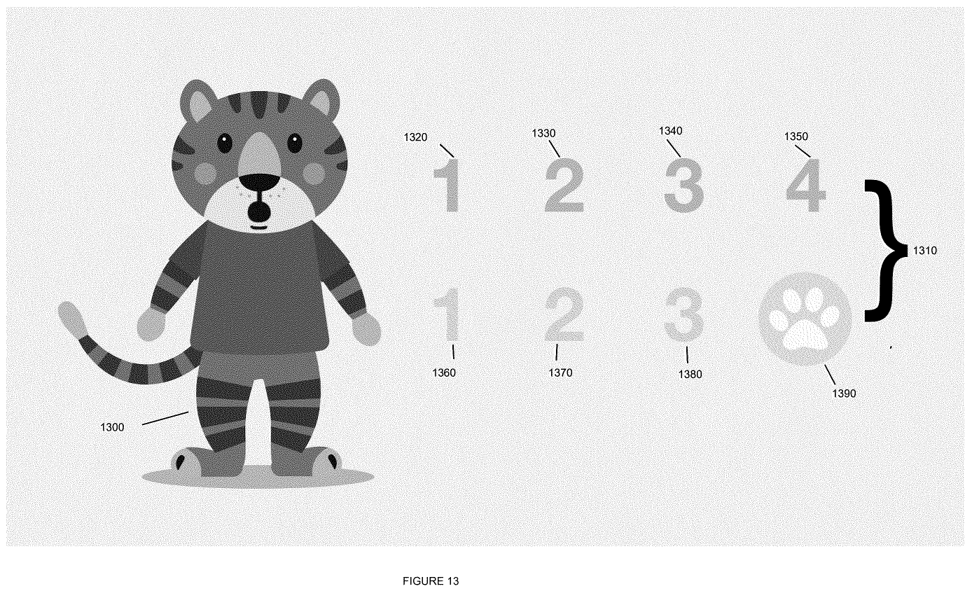

Similar to FIGS. 10-12, FIG. 13 is an illustration of an example of the user interface/display where the first line of the visual code 1310 requires no movement and only requires counting to the beat, as depicted by the numerals 1, 2, 3, and 4. The second line of visual code 1310 requires counting to the beat for the first three symbols 1320, 1330, 1340, and 1350. The second line of visual code 1310 begins with counting for three beats 1360, 1370, and 1380, followed by a PAWS or pause symbol 1390 requiring the user to pause in place.

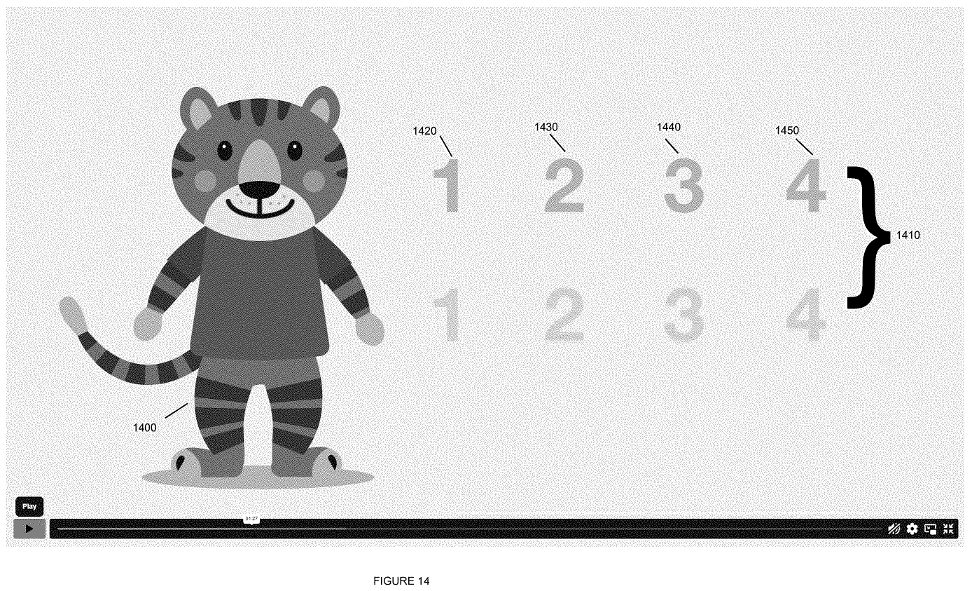

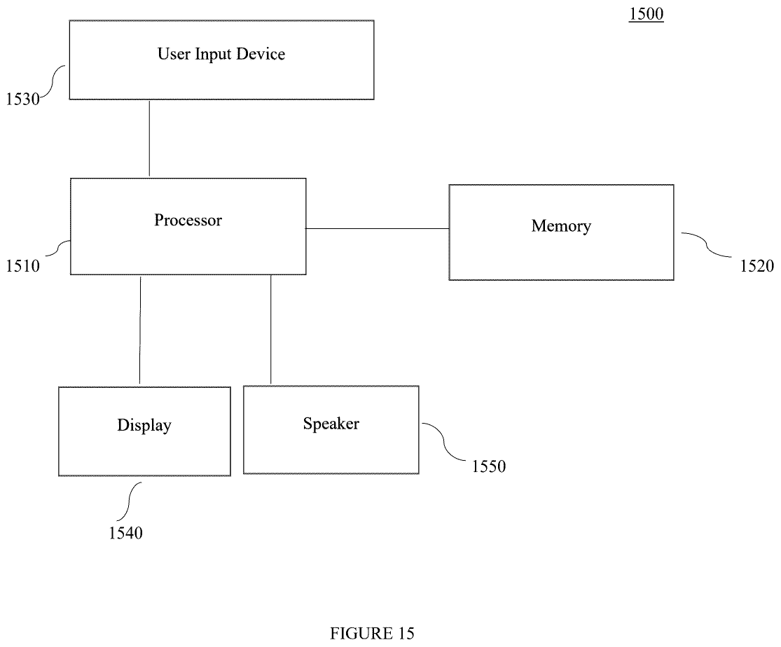

Similar to FIGS. 10-13, FIG. 14 is an illustration of an example of the user interface/display depicting a visual code 1410 which simply requires counting the beat for two lines, as depicted by the numerals 1, 2, 3, 4 repeated on both the first and second lines of visual code 1410.

The program is organized by Level, where each progressive Level increases the difficulty from the previous level. Each Level includes multiple Options, which are different combinations of the moves focusing on the same skills and difficulty. When users begin a new Level, they must first select Option 1, as it introduces the new moves for the level. After completing Option 1 one time, users may then select any of the Options in the Level.

Table 1 shows example sequences or sessions for Level 1 Options 1 and 2, and Level 5 Options 1 and 2. Example movements include bend, clap, pause, stomp, march, pat, raise the roof, cross, star, twist, pause, and climb the ladder. Bend refers to bending at the hips, knees, and ankles, lowering the body. Clap refers to bringing both hands bilaterally to the midline of the body. Movement/movement, such as Clap/clap, refers, for example, to completing the movement twice within one beat. Pause refers to putting both hands up and not moving. Stomp refers to stepping with indicated leg (left or right) with more force than a typical step, then bringing the foot back to center. March refers to lifting knee to hip height on alternating sides. Pat refers to bilaterally tapping with hands on the thighs. Raise the roof refers to bilaterally moving the arms from shoulder height to at or above the top of the head and back down. Cross refers to crossing the midline by moving a hand to touch the other shoulder (e.g., moving the right hand to tap the left shoulder). Star refers to bilaterally extending both arms and legs outward, arms up to the side and legs out to the side. Twist refers to rotating the upper and lower body in opposite directions, alternating direction, while moving vertically down and then up (the dance move referred to as the twist). Climb the ladder refers to contralaterally moving one arm and the other leg up, alternating sides, like climbing a ladder.

As shown in Table 1, Priming refers to an initial period similar to a warm-up period. The Priming period is followed by a period referred to as Introduce New Move 1, which introduces a first new move to be performed. This is followed by a period Practice New Move 1, which is a period for practicing the newly introduced first move. Next, is an In-Betweener period designed to transition to the next portion of the sequence. This next portion of the sequence is referred to as Introduce New Move 2, which introduces a second new move to be performed. This is followed by a period Practice New Move 2, which is a period for practicing the newly introduced second move. Next, is an In-Betweener period designed to transition to the next portion of the sequence. Following the second In-Betweener period, is a period referred to as First Performance, which includes the first new move and the second new move. The First Performance period is then followed by a Second Performance period, which may be quite similar or identical to the First Performance period.

Table 1. Example movements for each segment for Level 1 Options 1 and 2, and Level 5 Options 1 and 2. Numbers indicate counting the beat without movement.

TABLE 1
Example movements for each segment for Level 1 Options 1 and 2, and Level
5 Options 1 and 2. Numbers indicate counting the beat without movement.

| | Level 1, | Level 1, | | |
|---|---|---|---|---|
| Segment | Option 1 | Option 2 | Level 5, Option 1 | Level 5, Option 2 |
| Priming | 1 2 3 4; | 1 2 3 Bend; | Right Stomp 2 Left | Clap/Clap Pat Right |
| | 1 2 3 4; | 1 2 3 Clap; | Stomp 4; | Stomp; |
| | 1 2 3 4; | 1 2 3 | Twist (Down 1-2, Up 3- | Clap/Clap Pat Left |
| | 1 2 3 4 | Pause; | 4); | Stomp; |
| | 1 2 3 4; | (Pause 2 3 | Clap Over Head 2 Clap | Clap Clap Pat Clap; |
| | 1 2 3 4; | 4); | Over Head 4; | March Right Left Right |
| | 1 2 3 Pause; | 1 2 3 Bend; | Raise the Roof (4 Beats); | Left; |
| | (Pause 2 3 | 1 2 3 Clap; | Right Heel Forward (1 | Pat Pat Clap Right Stomp; |
| | 4) | 1 2 3 | 2), Left Heel Forward (3- | Pat Pat Clap Left Stomp; |
| | | Pause; | 4); | Pat Pat Clap Pat; |
| | | (Pause 2 3 | Right Knee Left Hand | March Right Left Right |
| | | 4); | Touch (1-2), | Left; |
| | | | Left Knee Right Hand | |
| | | | Touch (3-4); | |
| | | | Clap Over Head, 2 Clap | |
| | | | Over Head, 4; | |
| | | | Twist (Down1-2, Up 3- | |
| | | | 4); | |
| Introduce | 1 2 3 Bend; | 1 2 3 Clap; | Clap Clap Pat Right | Clap Cross Pat Clap Star; |
| New Move 1 | 1 2 3 Bend; | 1 2 3 Pat; | Stomp; | Clap Right Stomp Clap |
| | 1 2 3 Pause; | 1 2 3 | Clap Clap Pat Left | Left Stomp; |
| | (Pause 2 3 | Pause; | Stomp; | Clap Pat Clap Star; |
| | 4) | (Pause 2 3 | Clap Clap Pat Clap; | March Right Left Right |
| | 1 2 3 Bend; | 4); | March Right Left Right | Left; |
| | 1 2 3 Bend; | 1 2 3 Clap; | Left; | Clap Cross Pat Clap Star; |
| | 1 2 3 Pause; | 1 2 3 Pat; | Clap Clap Pat Right | Clap Right Stomp Clap |
| | (Pause 2 3 | 1 2 3 | Stomp; | Left Stomp; |
| | 4); | Pause; | Clap Clap Pat Left | Clap Pat Clap Star; |
| | | (Pause 2 3 | Stomp; | March Right Left Right |
| | | 4); | Clap Clap Pat Clap; | Left; |
| | | | March Right Left Right | |
| | | | Left; | |
| Practice | 1 2 3 Bend; | 1 2 3 Clap; | Clap Clap Pat Right | Clap Cross Pat Clap Star; |
| New Move 1 | 1 2 3 Bend; | 1 2 3 Pat; | Stomp; | Clap Right Stomp Clap |
| | 1 2 3 Pause; | 1 2 3 | Clap Clap Pat Left | Left Stomp; |
| | (Pause 2 3 | Pause; | Stomp; | Clap Pat Clap Star; |
| | 4); | (Pause 2 3 | Clap Clap Pat Clap; | March Right Left Right |
| | 1 2 3 Bend; | 4); | March Right Left Right | Left; |
| | 1 2 3 Bend; | 1 2 3 Clap; | Left; | Clap Cross Pat Clap Star; |
| | 1 2 3 Pause; | 1 2 3 Pat; | Clap Clap Pat Right | Clap Right Stomp Clap |
| | (Pause 2 3 | 1 2 3 | Stomp; | Left Stomp; |
| | 4); | Pause; | Clap Clap Pat Left | Clap Pat Clap Star; |
| | | (Pause 2 3 | Stomp; | March Right Left Right |
| | | 4); | Clap Clap Pat Clap | Left; |
| | | | March Right Left Right | |
| | | | Left; | |
| In- | Twist | Twist | Climb the Ladder | Climb the Ladder |
| betweener | | | | |
| Introduce | 1 2 3 Bend; | 1 2 3 Clap; | Pat Pat Clap Right | Right Stomp Clap Pat |
| New Move 2 | 1 2 3 Clap; | 1 2 3 Bend; | Stomp; | Star; |
| | 1 2 3 Pause; | 1 2 3 | Pat Pat Clap Left Stomp; | Left Stomp Clap Pat Star; |
| | (Pause 2 3 | Pause; | Pat Pat Clap Pat; | Clap Clap Cross Pat Star; |
| | 4); | (Pause 2 3 | March Right Left Right | March Right Left Right |
| | 1 2 3 Bend; | 4); | Left; | Left; |
| | 1 2 3 Clap; | 1 2 3 Pat; | Pat Pat Clap Right | Right Stomp Clap Pat |
| | 1 2 3 Pause; | 1 2 3 Bend; | Stomp; | Star; |
| | (Pause 2 3 | 1 2 3 | Pat Pat Clap Left Stomp; | Left Stomp Clap Pat Star; |
| | 4); | Pause; | Pat Pat Clap Pat; | Clap Clap Cross Pat Star; |
| | | (Pause 2 3 | March Right Left Right | March Right Left Right |
| | | 4); | Left; | Left; |
| Practice | 1 2 3 Bend; | 1 2 3 Clap; | Pat Pat Clap Right | Right Stomp Clap Pat |
| New Move 2 | 1 2 3 Clap; | 1 2 3 Bend; | Stomp; | Star; |
| | 1 2 3 Pause; | 1 2 3 | Pat Pat Clap Left Stomp; | Left Stomp Clap Pat Star; |
| | (Pause 2 3 | Pause; | Pat Pat Clap Pat; | Clap Clap Cross Pat Star; |
| | 4); | (Pause 2 3 | March Right Left Right | March Right Left Right |
| | 1 2 3 Bend; | 4); | Left; | Left; |
| | 1 2 3 Clap; | 1 2 3 Pat; | Pat Pat Clap Right | Right Stomp Clap Pat |
| | 1 2 3 Pause; | 1 2 3 Bend; | Stomp; | Star; |
| | (Pause 2 3 | 1 2 3 | Pat Pat Clap Left Stomp; | Left Stomp Clap Pat Star; |
| | 4); | Pause; | Pat Pat Clap Pat; | Clap Clap Cross Pat Star; |
| | | (Pause 2 3 | March Right Left Right | March Right Left Right |
| | | 4); | Left; | Left; |
| In- | Twist | Twist | Climb the Ladder | Climb the Ladder |
| betweener | | | | |
| Performance | 1 2 3 Bend; | 1 2 3 Clap; | Clap Clap Pat Right | Clap Cross Pat Clap Star; |
| (with new | 1 2 3 Bend; | 1 2 3 Pat; | Stomp; | Clap Right Stomp Clap |
| moves 1 and | 1 2 3 Pause; | 1 2 3 | Clap Clap Pat Left | Left Stomp; |
| 2) | (Pause 2 3 | Pause; | Stomp; | Clap Pat Clap Star; |
| | 4); | (Pause 2 3 | Clap Clap Pat Clap; | March Right Left Right |
| | 1 2 3 Bend; | 4); | March Right Left Right | Left; |
| | 1 2 3 Bend; | 1 2 3 Clap; | Left; | Right Stomp Clap Pat |
| | 1 2 3 Pause; | 1 2 3 Pat; | Pat Pat Clap Right | Star; |
| | (Pause 2 3 | 1 2 3 | Stomp; | Left Stomp Clap Pat Star; |
| | 4); | Pause; | Pat Pat Clap Left Stomp; | Clap Clap Cross Pat Star; |
| | 1 2 3 Bend; | (Pause 2 3 | Pat Pat Clap Pat; | March Right Left Right |
| | 1 2 3 Clap; | 4); | March Right Left Right | Left; |
| | 1 2 3 Pause; | 1 2 3 Clap; | Left; | Clap Cross Pat Clap Star; |
| | (Pause 2 3 | 1 2 3 Bend; | Clap Clap Pat Right | Clap Right Stomp Clap |
| | 4); | 1 2 3 | Stomp; | Left Stomp; |
| | 1 2 3 Bend; | Pause; | Clap Clap Pat Left | Clap Pat Clap Star; |
| | 1 2 3 Clap; | (Pause 2 3 | Stomp; | March Right Left Right |
| | 1 2 3 Pause; | 4); | Clap Clap Pat Clap; | Left; |
| | (Pause 2 3 | 1 2 3 Pat; | March Right Left Right | Right Stomp Clap Pat |
| | 4); | 1 2 3 Bend; | Left; | Star; |
| | | 1 2 3 | Pat Pat Clap Right | Left Stomp Clap Pat Star; |
| | | Pause; | Stomp; | Clap Clap Cross Pat Star; |
| | | (Pause 2 3 | Pat Pat Clap Left Stomp; | March Right Left Right |
| | | 4); | Pat Pat Clap Pat; | Left; |
| | | | March Right Left Right | |
| | | | Left; | |
| Performance | 1 2 3 Bend; | 1 2 3 Clap; | Clap Clap Pat Right | Clap Pat Clap Star; |
| (with new | 1 2 3 Bend; | 1 2 3 Pat; | Stomp; | Clap Right Stomp Clap |
| moves 1 and | 1 2 3 Pause; | 1 2 3 | Clap Clap Pat Left | Left Stomp; |
| 2) | (Pause 2 3 | Pause; | Stomp; | Clap Pat Clap Star; |
| | 4); | (Pause 2 3 | Clap Clap Pat Clap; | March Right Left Right |
| | 1 2 3 Bend; | 4); | March Right Left Right | Left; |
| | 1 2 3 Bend; | 1 2 3 Clap; | Left; | Right Stomp Clap Pat |
| | 1 2 3 Pause; | 1 2 3 Pat; | Pat Pat Clap Right | Star; |
| | (Pause 2 3 | 1 2 3 | Stomp; | Left Stomp Clap Pat Star; |
| | 4); | Pause; | Pat Pat Clap Left Stomp; | Clap Clap Pat Star; |
| | 1 2 3 Bend; | (Pause 2 3 | Pat Pat Clap Pat; | March Right Left Right |
| | 1 2 3 Clap; | 4); | March Right Left Right | Left; |
| | 1 2 3 Pause; | 1 2 3 Clap; | Left; | Clap Pat Clap Star; |
| | (Pause 2 3 | 1 2 3 Bend; | Clap Clap Pat Right | Clap Right Stomp Clap |
| | 4); | 1 2 3 | Stomp; | Left Stomp; |
| | 1 2 3 Bend; | Pause; | Clap Clap Pat Left | Clap Pat Clap Star; |
| | 1 2 3 Clap; | (Pause 2 3 | Stomp; | March Right Left Right |
| | 1 2 3 Pause; | 4); | Clap Clap Pat Clap; | Left; |
| | (Pause 2 3 | 1 2 3 Pat; | March Right Left Right | Right Stomp Clap Pat |
| | 4); | 1 2 3 Bend; | Left; | Star; |
| | | 1 2 3 | Pat Pat Clap Right | Left Stomp Clap Pat Star; |
| | | Pause; | Stomp; | Clap Clap Pat Star; |
| | | (Pause 2 3 | Pat Pat Clap Left Stomp; | March Right Left Right |
| | | 4); | Pat Pat Clap Pat; | Left; |
| | | | March Right Left Right | |
| | | | Left; | |

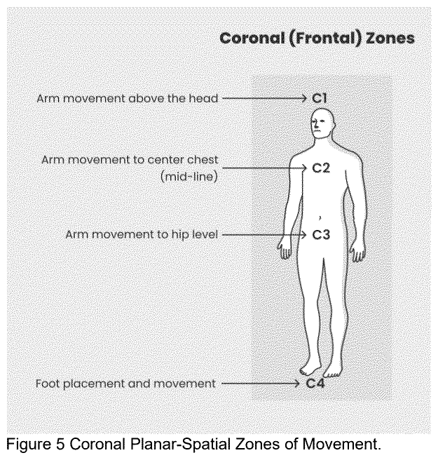

The exemplary embodiment uses several dimensions to increase movement complexity. The movements are designed, as level complexity increases, to cross the three planes of the body shown in FIGS. 5-8: the coronal (frontal) plane, the sagittal plane (left-right), and the transverse plane (upper-lower). The movements are defined in 12 planar-spatial zones illustrated in FIGS. 5-8. Referring now to FIG. 5, therein is illustrated the coronal planar-spatial zones wherein the coronal plane separates the front of the body from the back of the body. The coronal planar-spatial zones include four locations designated C1, C2, C3, and C4. Moving across the coronal plane includes zone C1 and refers to, for example, bilateral movements above the head; zone C2 refers to, for example, bringing hands bilaterally to the midline at the chest; zone C3 refers to, for example, bilateral hand movements at the hip; and zone C4 refers to, for example, the neutral area for feet placement to maintain balance when not explicitly moving the feet.

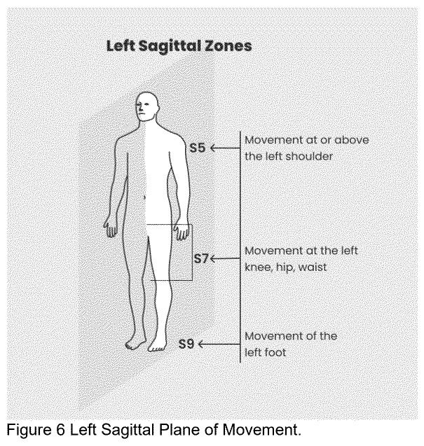

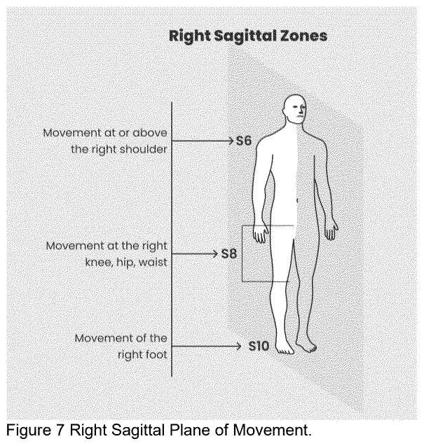

Referring now to FIG. 6, therein is illustrated the left sagittal plane of movement, where the sagittal plane separates the left and right sides of the body. The left-side sagittal planar-spatial zones include three locations S5, S7, and S9. Referring now to FIG. 7, the right-side sagittal plane has corresponding zones with even numbers, i.e., S6, S8, and S10. With reference to the sagittal plane, movements correspond to zones which are divided into left (odd numbers) and right (even numbers) sides of the body. Zones S5 and S6 refer to, for example, ipsilateral movements of an arm above the shoulder, S7 and S8 refer to, for example, movement at the waist, hip, and knee, and S9 and S10 refer to, for example, movement of each foot away from the neutral zone of C4.

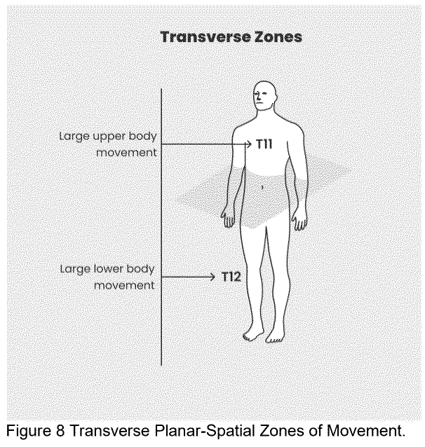

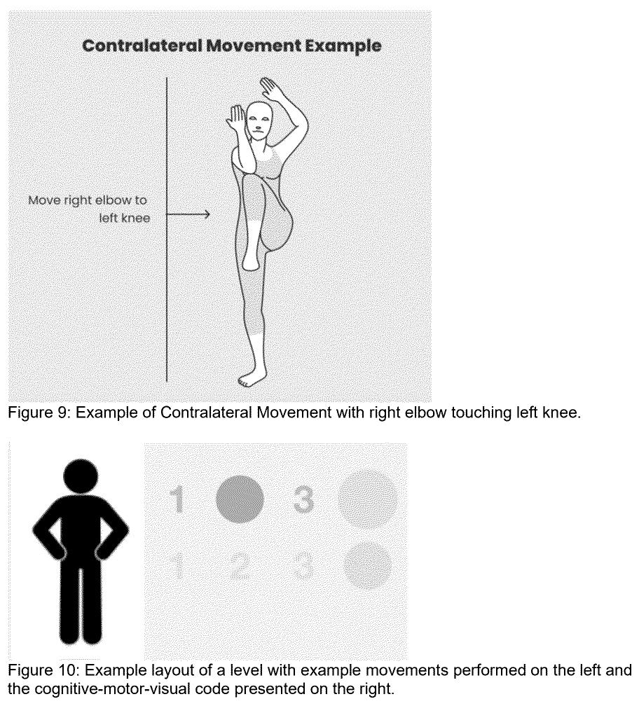

Referring now to FIG. 8, therein are illustrated the transverse planar-spatial zones of movement. The transverse plane separates the upper and lower body. The transverse planar-spatial zones include two locations designated T11 and T12, corresponding to the upper body and lower body, respectively. In the transverse plane, movements corresponding to T11 refer to, for example, large upper body movement and movements corresponding to T12 refer to, for example, large lower body movements. Movements in the transverse plane zones T11 and T12 generally pass through multiple coronal and sagittal zones (e.g., rotating the arm as if swinging a lasso, performing the “grapevine” line dancing move with the feet) but only within one transverse zone.

The number of zones used in the movements increases as participants progress to higher levels in the program (See Table 2 below). Thus, intentional movement through the coronal, sagittal and transverse planes of the body including movements forward, backward and side to side are used to slowly increase complexity. In Level 1, all movements involve only the upper body and are kept close to the center of the body (zones C2-C4) or include very simple movements of the hands to the left or right shoulder (zones S5-S6). By Level 4, movements occur in all 3 planes across 12 zones with predominantly foundational (easy) movements. In Level 6, movements start combining upper and lower body movements together. In Level 8, all movement types have been introduced, including rotational movements that cross between zones. In Level 9, the movements are easier because this level has the greatest cognitive demands, as outlined below.

Table 2. Planar-Spatial Zones of Movement used for each level. The level numbers refer to levels of increasing difficulty and/or complexity. The alphabetic or alphanumeric entries denote different types of movement, as well as different zones where the movement occurs. For example, C refers to coronal plane, while C1 refers to zone 1 of the coronal plane, C2 refers to zone 2 of the coronal plane, and so on (see FIG. 5). Similarly, S refers to sagittal plane, while S5 refers to zone 5 of the sagittal plane, S6 refers to zone 6 of the sagittal plane and so on (see FIGS. 6 and 7). T refers to the transverse plane, while T11 refers to zone 11 of the transverse plane, T12 refers to zone 12 of the sagittal plane, and so on (see FIG. 8). U refers to upper body, L refers to lower body, F refers to foundational (low level of difficulty) movement, M refers to medium difficulty, and H refers to high difficulty.

### Table 2

TABLE 2

| | Planar-Spatial Movement Zones | | | | | | | | | | | |
|---|---|---|---|---|---|---|---|---|---|---|---|---|
| Level | C1 | C2 | C3 | C4 | S5 | S6 | S7 | S8 | S9 | S10 | T11 | T12 |
| 1 | | U-F | U-F | | U-F | U-F | | | | | | |
| 2 | U-F | U-F | U-F | U-F | U-F | U-F | L-M | L-M | L-M | | | |
| 3 | U-F | U-F | U-F | U-F | U-F | U-F | U-H | L-M | L-M | L-M | L-M | |
| 4 | U-M | U-F | U-F | U-F | U-F | U-M | U-H | U-H | L-F | L-F | U-H | U-H |
| 5 | | U-F | U-F | U-F | U-M | U-M | L-M | L-M | L-M | L-M | L-M | L-M |
| 6 | | U-F | U-F | U-F | U-M | U-M | U-M/ | U-M/ | U-M/ | U-M/ | U-M/ | U-M/ |
| | | | | | | | L-H | L-H | L-H | L-H | L-H | L-H |
| 7 | | U-F | U-F | U-F | U-H | U-H | L-H | L-H | L-H | L-H | L-H | L-H |
| 8 | U-H | | | L-H | | | | | L-H | L-H | L-H | L-H |
| 9 | | U-F | U-F | U-F | U-M | U-M | L-M | L-M | L-M | L-M | L-M | L-M |

In addition to increasing the number of zones used, specific types of movements that meet at the midline, cross the midline, and are rotational are developmentally important and add a greater level of both cognitive and motor complexity. The complexity of the movements also increases from simple ipsilateral and bilateral movements up to contralateral movements (Table 3 below).

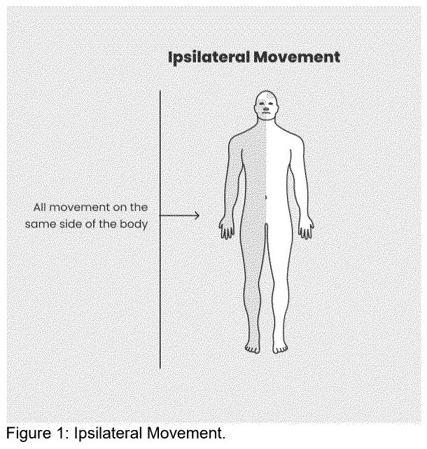

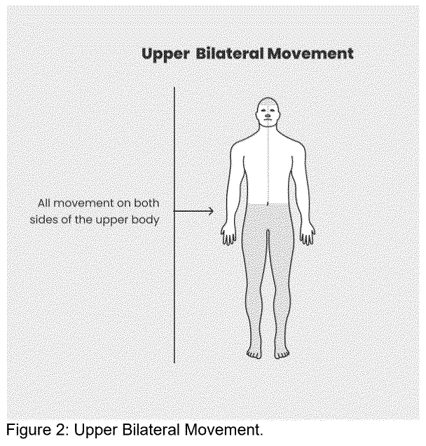

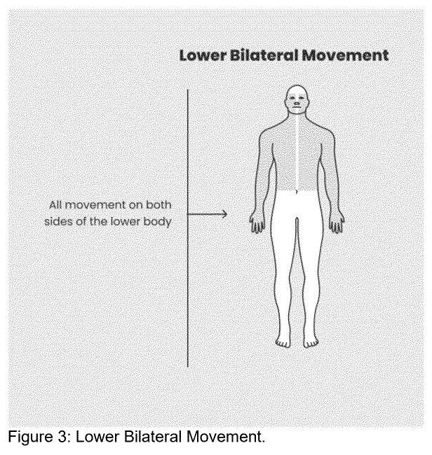

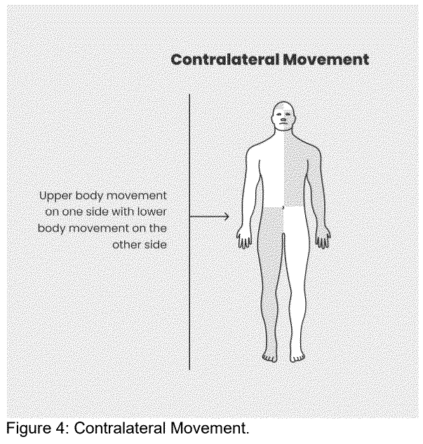

FIGS. 1-4 show examples of ipsilateral, bilateral, and contralateral moves. Specifically, FIG. 1 illustrates ipsilateral movement, or movement that all occurs on the same side of the body, such as moving both the left arm and the left leg. FIG. 2 illustrates upper bilateral movement, or movement of the upper body that occurs on both sides of the body, such as clapping the left and right hands together. FIG. 3 illustrates lower bilateral movement, or movement of the lower body that occurs on both sides of the body, such as jumping. FIG. 4 illustrates contralateral movement, or movement that occurs across the diagonal of the human body, such as moving the left arm and right leg at the same time.

Moves that cross the midline, are moves where a limb from one side of the body crosses the “midline” (line down the middle of the body) to the other side of the body (e.g., reaching the left arm across to the right side of the body). Rotational moves may only require movement from one side of the body, but the movement crosses to the other side and requires balance and skilled weight shifting to perform (e.g., moving as if swinging a lasso).

Table 3 below provides an indication of the type of movement lateralization which is incorporated within each level of the movement sequence.

Table 3. Lateralization (ipsilateral, bilateral, contralateral, crossing midline, rotational) of movements in each level (which relationships to side of body or midline of body are used).

TABLE 3
Lateralization (ipsilateral, bilateral, contralateral, crossing
midline, rotational) of movements in each level (which relationships
to side of body or midline of body are used).

| | Movement Lateralization | | | | |
|---|---|---|---|---|---|
| | | Contralateral | | | |
| | Ipsilateral | (opposite | At | Cross | |
| Level | (same side) | sides) | Midline | Midline | Rotational |
| 1 | | | x | | |
| 2 | x | | x | | |
| 3 | x | x | x | | |
| 4 | x | x | x | x | |
| 5 | x | | x | | |
| 6 | x | x | x | x | |
| 7 | x | x | x | | |
| 8 | x | x | | | x |
| 9 | x | x | x | | |

Movements also correspond to the beat in the presented music. All music is in 4/4 beat, with 4 beats per measure, so moves can be quarter note moves (on the beat), eighth note moves (two on the beat, e.g., double clap), half note moves (held for 2 beats), and whole note moves (held for an entire measure of 4 beats). Early levels include quarter and eighth note moves, while half and whole notes are introduced later as they are more difficult.

An additional element of complexity is the absence of auditory cues at higher levels. In early levels, there are audio or spoken cues on the beat, as well as the visual code to alert the student as to which movement to complete. At later levels, the auditory cues disappear, requiring reading or interpreting the cognitive-motor-visual code to be able to anticipate the next moves and be able to complete the movement on the beat.

### Skills Targeted by Level

### Sensory and Motor Skills

Each level in the sequence targets specific sensory and motor skills. Later levels build on skills from earlier levels and add more complex skills or movements. Table 4 below shows which skills are included in each level. Motor planning refers to planning intentional movements, i.e., not automatic reflex movements. Balance refers to the body remaining upright and stable regardless of position of body parts. Weight Shift refers to moving the majority of the body's weight from one position to another. Spatial Awareness refers to knowledge of where other people and objects are in space as well as where an individual's body is in space. Beat Competency refers to the ability to move in time with music. Coordination refers to integrating complex, sequential actions within one movement (e.g., stepping both forward and backward within one beat).

### Table 4. Sensory and Motor Skills by Level.

TABLE 4
Sensory and Motor Skills by Level.

| | Motor | | Weight | Spatial | Beat | Coordi- |
|---|---|---|---|---|---|---|
| Level | Planning | Balance | Shift | Awareness | Competency | nation |
| 1 | x | x | x | x | | |
| 2 | x | x | x | x | | |
| 3 | x | x | x | x | x | |
| 4 | x | x | x | x | x | |
| 5 | x | x | x | x | x | |
| 6 | x | x | x | x | x | |
| 7 | x | x | x | x | x | x |
| 8 | x | x | x | x | x | x |
| 9 | x | x | x | x | x | x |

### Cognitive Skills

Each level of the sequence targets specific cognitive skills. Later levels build on skills from earlier levels and add more complex skills or movements. Table 5 below shows which skills are included in each level. Self-regulation refers to monitoring and controlling one's thoughts, emotions, and behaviors. Attention refers to focusing on some information while ignoring other information. Memory refers to recalling and using previously learned or known information. Response Inhibition refers to stopping oneself from automatically reacting to a stimulus, either internal or external. Cognitive Flexibility refers to being able to change plans or adjust actions, either in response to a goal or due to changing goals. Planning refers to determining what one will think, do, or say with regard to a goal or set of steps.

### Table 5. Cognitive Skills by Level.

TABLE 5
Cognitive Skills by Level.

| | Self- | Atten- | | Response | Cognitive | Plan- |
|---|---|---|---|---|---|---|
| Level | regulation | tion | Memory | Inhibition | Flexibility | ning |
| 1 | x | x | x | x | | |
| 2 | x | x | x | x | | x |
| 3 | x | x | x | x | | x |
| 4 | x | x | x | x | x | x |
| 5 | x | x | x | x | x | x |
| 6 | x | x | x | x | x | x |
| 7 | x | x | x | x | x | x |
| 8 | x | x | x | x | x | x |
| 9 | x | x | x | x | x | x |

### Rules by Level

### Level 1

In Level 1, all movements are on beat 4, which provides the most time to prepare for and anticipate the movement. There are upper body and lower body movements, but movements do not cross the midline or the transverse plane (from upper body to lower body or vice versa). There are both quarter and eighth note movements (e.g., a double clap). Level 1 also includes pause, where there are no movements, to practice response inhibition. All movements occur within the coronal plane, so there are no forward or backward movements.

### Level 2

In Level 2, movements are on beats 2 and 4, which provides some time to prepare and anticipate the movement, but less time than in Level 1. All movements from Level 1 are included for Level 2. Additionally, movements also include crossing the midline for upper body moves. Movements expand to move along both sagittal and coronal planes (e.g., heel forward).

### Level 3

In Level 3, movements occur on beats 1 and 3. This provides less time to prepare for movements, especially the first movement. All movements from Levels 1 and 2 are included as part of Level 3. Level 3 introduces movements that cross the transverse plane and midline (e.g., dig motion to the left). The lower body moves do not cross the midline.

### Level 4

In Level 4, movements occur on every beat. In addition to movements in previous levels, Level 4 introduces movements that cross the midline and transverse plane for both upper and lower body movements (e.g., tap left hand to right knee). Level 4 also introduces half note movements (movements that take 2 beats to complete).

### Level 5

In Level 5, movements occur on every beat and can include eighth note, quarter note, and half note movements. In addition to movements from previous levels, Level 5 introduces holding a movement for two beats (e.g., step left and stay to the left for an additional beat). Level 5 includes more movements that cross the coronal plane (e.g., walking forward or backward).

### Level 6

In Level 6, cross lateral movements in the dorsal coronal plane (Heel touch opposite hand) are introduced. Movements also cover more horizontal space to the left and right with the slide movement.

### Level 7

In Level 7, rhythmic movement forward and back in the ventral dorsal plane begins with a simple salsa step. This movement is combined with other complex movements including heel touch and step kick, requiring the participant to integrate gross motor movements in multiple planes with some quick and some slower movements.

### Level 8

In Level 8, gross motor movements traverse the sagittal and coronal planes with high complexity.

### Level 9

In Level 9, the auditory cueing for the movements disappears, now the participants have to read and respond to the cognitive-visual-motor code without words.

Depending on the circumstances, the inventive method described and claimed herein may be implemented in hardware or in software. Implementation may occur on a digital storage medium, in particular a disc or CD with electronically readable control signals which can interact with a programmable computer system such that the method is performed. Generally, the invention thus also consists in a computer program product with a program code, stored on a machine-readable carrier, for performing the method, when the computer program product runs on a computer. In other words, the invention may thus be realized as a computer program having a program code for performing the method, when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of generating integrated progressively complex audiovisual sequences to strengthen cognition, the method comprising the following steps:
generating and projecting to a user, multiple levels of audiovisual instructions corresponding to a series of progressively complex motor movements to be performed by the user, the instructions being presented in a predetermined developmental order;
increasing a complexity of the multiple levels of audiovisual instructions over time by increasing cognitive processing and increasing sensory motor processing demands.

2. The method of claim 1, wherein the instructions begin with vertical sequences and patterns of movement.

3. The method of claim 1, wherein the movements begin with simple unilateral and bilateral movements.

4. The method of claim 1, wherein the movements include movements crossing a coronal, sagittal, or transverse body plane.

5. The method of claim 4, wherein movements crossing the coronal plane involve one or more coronal planar spatial zones, movements crossing the sagittal plane involve one or more sagittal planar spatial zones, and movements crossing the transverse plane involve one or more transverse planar spatial zones.

6. The method of claim 4, wherein the instructions begin with a low level of complexity involving crossing one body plane, and increase to a higher level of complexity involving crossing all three body planes.

7. The method of claim 1, wherein the audio portion of the instructions includes music which is performed in 4/4 time.

8. The method of claim 4, wherein the instructions are generated and presented according to the following sequence of levels and planar spatial movement zones:

| | Planar-Spatial Movement Zones | | | | | | | | | | | |
|---|---|---|---|---|---|---|---|---|---|---|---|---|
| Level | C1 | C2 | C3 | C4 | S5 | S6 | S7 | S8 | S9 | S10 | T11 | T12 |
| 1 | | U-F | U-F | | U-F | U-F | | | | | | |
| 2 | U-F | U-F | U-F | U-F | U-F | U-F | L-M | L-M | L-M | | | |
| 3 | U-F | U-F | U-F | U-F | U-F | U-F | U-H | L-M | L-M | L-M | L-M | |
| 4 | U-M | U-F | U-F | U-F | U-F | U-M | U-H | U-H | L-F | L-F | U-H | U-H |
| 5 | | U-F | U-F | U-F | U-M | U-M | L-M | L-M | L-M | L-M | L-M | L-M |
| 6 | | U-F | U-F | U-F | U-M | U-M | U-M/ | U-M/ | U-M/ | U-M/ | U-M/ | U-M/ |
| | | | | | | | L-H | L-H | L-H | L-H | L-H | L-H |
| 7 | | U-F | U-F | U-F | U-H | U-H | L-H | L-H | L-H | L-H | L-H | L-H |
| 8 | U-H | | | L-H | | | | | L-H | L-H | L-H | L-H |
| 9 | | U-F | U-F | U-F | U-M | U-M | L-M | L-M | L-M | L-M | L-M | L-M |

where C1-C4 refer to coronal plane movements, S5-S9 refer to sagittal plane movements, T11-T12 refer to transverse plane movements, U refers to upper body movements, L refers to lower body movements, F refers to foundational (low level of difficulty) movement, M refers to medium difficulty movements, and H refers to high difficulty movements.

9. The method of claim 8, wherein movements are indicated to be quarter note moves on the beat, eighth note moves with a double movement, half note movements held for two beats, or whole note movements held for four beats.

10. The method of claim 9, wherein in Level 1, all movements are on beat four.

11. The method of claim 9, wherein in Level 2, all movements are on beats two and four.

12. The method of claim 9, wherein in Level 3, all movements are on beats one and three.

13. The method of claim 9, wherein in Level 4, movements are on every beat.

14. The method of claim 9, wherein in Level 5, movements are on every beat and comprise eighth note, quarter note, or half note movements.

15. The method of claim 9, wherein in Level 6, movements include cross lateral movement in the dorsal coronal plane.

16. The method of claim 9, wherein in Level 7, movements include rhythmic forward and backward movements.

17. The method of claim 9, wherein in Level 8, movements include gross motor movements traversing the sagittal and coronal planes.

18. The method of claim 9, wherein the instructions begin with quarter and eighth note movements and progress to half and whole note movements.

19. The method of claim 1, wherein the series of movements is divided into a plurality of portions, each portion of the series of movements being followed by an instruction for a period of deep breathing by the user.

20. The method of claim 1, wherein the audiovisual instructions projected to the user include instructions for a current movement and instructions for a subsequent movement which follows the current movement.

21. The method of claim 20, wherein instructions for the current and subsequent movements are conveyed using a cognitive motor visual code.

22. The method of claim 21, wherein the cognitive motor visual code includes symbols, colors, or graphics corresponding to each movement.

23. The method of claim 7, wherein at least one of the movements is completed over more than one beat of music.

24. The method of claim 22, wherein one line of the cognitive motor visual code corresponds to one measure of music.

25. The method of claim 24, wherein a plurality of lines of the cognitive motor visual code are presented to the user simultaneously.

26. The method of claim 1, wherein a plurality of users complete the movements in a group setting, and a determination is made to move to a next level of sequences when a predetermined minimum percentage of the plurality of users is able to complete the movements correctly.

27. The method of claim 26, wherein the predetermined minimum percentage is at least 80%.

28. The method of claim 1, wherein a determination is made to move the user to a next level of sequences when a predetermined minimum percentage of the movements are completed correctly by the user.

29. The method of claim 28, wherein the predetermined minimum percentage is at least 80%.

30. The method of claim 1, wherein the movements include bend, clap, pause, stomp, march, pat, raise the roof, cross, star, twist, or climb the ladder.

31. A method of generating integrated progressively complex audiovisual sequences to strengthen cognition, the method comprising the following steps:
generating and projecting to a user, audiovisual instructions corresponding to a series of progressively complex motor movements to be performed by the user, the instructions being presented in a predetermined developmental order;
wherein the audio portion of the instructions includes music which is performed in 4/4 time;
said instructions including a plurality of levels, each level having a plurality of options which may be selected for that particular level;
each level including a priming portion of a first plurality of beats, followed by a first new move introduction of a second plurality of beats, followed by a practice period of the first new move of a third plurality of beats, followed by a first cognitive movement break for a fourth plurality of beats, followed by a second new move of a fifth plurality of beats, a practice period of the second new move of a sixth plurality of beats, followed by a second cognitive movement break for a seventh plurality of beats, followed by at least one performance period of an eighth plurality of beats combining the first new move and the second new move.

32. The method of claim 31 wherein the sequences are generated according to the following sequence:

| | Level 1, | Level 1, | | |
|---|---|---|---|---|
| Segment | Option 1 | Option 2 | Level 5, Option 1 | Level 5, Option 2 |
| Priming | 1 2 3 4; | 1 2 3 Bend; | Right Stomp 2 | Clap/Clap Pat Right |
| | 1 2 3 4; | 1 2 3 Clap; | Left Stomp 4; | Stomp; |
| | 1 2 3 4; | 1 2 3 | Twist (Down 1-2, Up 3-4); | Clap/Clap Pat Left |
| | 1 2 3 4 | Pause; | Clap Over Head 2 | Stomp; |
| | 1 2 3 4; | (Pause 2 3 4); | Clap Over Head 4; | Clap Clap Pat Clap; |
| | 1 2 3 4; | 1 2 3 Bend; | Raise the Roof (4 Beats); | March Right Left Right |
| | 1 2 3 | 1 2 3 Clap; | Right Heel Forward (1 2), | Left; |
| | Pause; | 1 2 3 | Left Heel Forward (3-4); | Pat Pat Clap Right Stomp; |
| | (Pause 2 3 4) | Pause; | Right Knee Left Hand | Pat Pat Clap Left Stomp; |
| | | (Pause 2 3 4); | Touch (1-2), | Pat Pat Clap Pat; |
| | | | Left Knee Right Hand | March Right Left Right |
| | | | Touch (3-4); | Left; |
| | | | Clap Over Head, | |
| | | | 2 Clap Over Head, 4; | |
| | | | Twist (Down1-2 , Up 3-4); | |
| Introduce | 1 2 3 Bend; | 1 2 3 Clap; | Clap Clap Pat Right | Clap Cross Pat Clap Star; |
| New Move 1 | 1 2 3 Bend; | 1 2 3 Pat; | Stomp; | Clap Right Stomp Clap |
| | 1 2 3 | 1 2 3 | Clap Clap Pat Left | Left Stomp; |
| | Pause; | Pause; | Stomp; | Clap Pat Clap Star; |
| | (Pause 2 3 4) | (Pause 2 3 4); | Clap Clap Pat Clap; | March Right Left Right |
| | 1 2 3 Bend; | 1 2 3 Clap; | March Right Left Right | Left; |
| | 1 2 3 Bend; | 1 2 3 Pat; | Left; | Clap Cross Pat Clap Star; |
| | 1 2 3 | 1 2 3 | Clap Clap Pat Right | Clap Right Stomp Clap |
| | Pause; | Pause; | Stomp; | Left Stomp; |
| | (Pause 2 3 4); | (Pause 2 3 4); | Clap Clap Pat Left | Clap Pat Clap Star; |
| | | | Stomp; | March Right Left Right |
| | | | Clap Clap Pat Clap; | Left; |
| | | | March Right Left Right | |
| | | | Left; | |
| Practice New | 1 2 3 Bend; | 1 2 3 Clap; | Clap Clap Pat Right | Clap Cross Pat Clap Star; |
| Move 1 | 1 2 3 Bend; | 1 2 3 Pat; | Stomp; | Clap Right Stomp Clap |
| | 1 2 3 | 1 2 3 | Clap Clap Pat Left | Left Stomp; |
| | Pause; | Pause; | Stomp; | Clap Pat Clap Star; |
| | (Pause 2 3 4); | (Pause 2 3 4); | Clap Clap Pat Clap; | March Right Left Right |
| | 1 2 3 Bend; | 1 2 3 Clap; | March Right Left Right | Left; |
| | 1 2 3 Bend; | 1 2 3 Pat; | Left; | Clap Cross Pat Clap Star; |
| | 1 2 3 | 1 2 3 | Clap Clap Pat Right | Clap Right Stomp Clap |
| | Pause; | Pause; | Stomp; | Left Stomp; |
| | (Pause 2 3 4); | (Pause 2 3 4); | Clap Clap Pat Left | Clap Pat Clap Star; |
| | | | Stomp; | March Right Left Right |
| | | | Clap Clap Pat Clap | Left; |
| | | | March Right Left Right | |
| | | | Left; | |
| In-betweener | Twist | Twist | Climb the Ladder | Climb the Ladder |
| Introduce | 1 2 3 Bend; | 1 2 3 Clap; | Pat Pat Clap Right | Right Stomp Clap Pat |
| New Move 2 | 1 2 3 Clap; | 1 2 3 Bend; | Stomp; | Star; |
| | 1 2 3 | 1 2 3 | Pat Pat Clap Left Stomp; | Left Stomp Clap Pat Star; |
| | Pause; | Pause; | Pat Pat Clap Pat; | Clap Clap Cross Pat Star; |
| | (Pause 2 3 4); | (Pause 2 3 4); | March Right Left Right | March Right Left Right |
| | 1 2 3 Bend; | 1 2 3 Pat; | Left; | Left; |
| | 1 2 3 Clap; | 1 2 3 Bend; | Pat Pat Clap Right | Right Stomp Clap Pat |
| | 1 2 3 | 1 2 3 | Stomp; | Star; |
| | Pause; | Pause; | Pat Pat Clap Left Stomp; | Left Stomp Clap Pat Star; |
| | (Pause 2 3 4); | (Pause 2 3 4); | Pat Pat Clap Pat; | Clap Clap Cross Pat Star; |
| | | | March Right Left Right | March Right Left Right |
| | | | Left; | Left; |
| Practice New | 1 2 3 Bend; | 1 2 3 Clap; | Pat Pat Clap Right | Right Stomp Clap Pat |
| Move 2 | 1 2 3 Clap; | 1 2 3 Bend; | Stomp; | Star; |
| | 1 2 3 | 1 2 3 | Pat Pat Clap Left Stomp; | Left Stomp Clap Pat Star; |
| | Pause; | Pause; | Pat Pat Clap Pat; | Clap Clap Cross Pat Star; |
| | (Pause 2 3 4); | (Pause 2 3 4); | March Right Left Right | March Right Left Right |
| | 1 2 3 Bend; | 1 2 3 Pat; | Left; | Left; |
| | 1 2 3 Clap; | 1 2 3 Bend; | Pat Pat Clap Right | Right Stomp Clap Pat |
| | 1 2 3 | 1 2 3 | Stomp; | Star; |
| | Pause; | Pause; | Pat Pat Clap Left Stomp; | Left Stomp Clap Pat Star; |
| | (Pause 2 3 4); | (Pause 2 3 4); | Pat Pat Clap Pat; | Clap Clap Cross Pat Star; |
| | | | March Right Left Right | March Right Left Right |
| | | | Left; | Left; |
| In-betweener | Twist | Twist | Climb the Ladder | Climb the Ladder |
| Performance | 1 2 3 Bend; | 1 2 3 Clap; | Clap Clap Pat Right | Clap Cross Pat Clap Star; |
| (with new | 1 2 3 Bend; | 1 2 3 Pat; | Stomp; | Clap Right Stomp Clap |
| moves 1 and | 1 2 3 | 1 2 3 | Clap Clap Pat Left | Left Stomp; |
| 2 ) | Pause; | Pause; | Stomp; | Clap Pat Clap Star; |
| | (Pause 2 3 4); | (Pause 2 3 4); | Clap Clap Pat Clap; | March Right Left Right |
| | 1 2 3 Bend; | 1 2 3 Clap; | March Right Left Right | Left; |
| | 1 2 3 Bend; | 1 2 3 Pat; | Left; | Right Stomp Clap Pat |
| | 1 2 3 | 1 2 3 | Pat Pat Clap Right | Star; |
| | Pause; | Pause; | Stomp; | Left Stomp Clap Pat Star; |
| | (Pause 2 3 4); | (Pause 2 3 4); | Pat Pat Clap Left Stomp; | Clap Clap Cross Pat Star; |
| | 1 2 3 Bend; | 1 2 3 Clap; | Pat Pat Clap Pat; | March Right Left Right |
| | 1 2 3 Clap; | 1 2 3 Bend; | March Right Left Right | Left; |
| | 1 2 3 | 1 2 3 | Left; | Clap Cross Pat Clap Star; |
| | Pause; | Pause; | Clap Clap Pat Right | Clap Right Stomp Clap |
| | (Pause 2 3 4); | (Pause 2 3 4); | Stomp; | Left Stomp; |
| | 1 2 3 Bend; | 1 2 3 Pat; | Clap Clap Pat Left | Clap Pat Clap Star; |
| | 1 2 3 Clap; | 1 2 3 Bend; | Stomp; | March Right Left Right |
| | 1 2 3 | 1 2 3 | Clap Clap Pat Clap; | Left; |
| | Pause; | Pause; | March Right Left Right | Right Stomp Clap Pat |
| | (Pause 2 3 4); | (Pause 2 3 4); | Left; | Star; |
| | | | Pat Pat Clap Right | Left Stomp Clap Pat Star; |
| | | | Stomp; | Clap Clap Cross Pat Star; |
| | | | Pat Pat Clap Left Stomp; | March Right Left Right |
| | | | Pat Pat Clap Pat; | Left; |
| | | | March Right Left Right | |
| | | | Left; | |
| Performance | 1 2 3 Bend; | 1 2 3 Clap; | Clap Clap Pat Right | Clap Pat Clap Star; |
| (with new | 1 2 3 Bend; | 1 2 3 Pat; | Stomp; | Clap Right Stomp Clap |
| moves 1 and | 1 2 3 | 1 2 3 | Clap Clap Pat Left | Left Stomp; |
| 2 ) | Pause; | Pause; | Stomp; | Clap Pat Clap Star; |
| | (Pause 2 3 4); | (Pause 2 3 4); | Clap Clap Pat Clap; | March Right Left Right |
| | 1 2 3 Bend; | 1 2 3 Clap; | March Right Left Right | Left; |
| | 1 2 3 Bend; | 1 2 3 Pat; | Left; | Right Stomp Clap Pat |
| | 1 2 3 | 1 2 3 | Pat Pat Clap Right | Star; |
| | Pause; | Pause; | Stomp; | Left Stomp Clap Pat Star; |
| | (Pause 2 3 4); | (Pause 2 3 4); | Pat Pat Clap Left Stomp; | Clap Clap Pat Star; |
| | 1 2 3 Bend; | 1 2 3 Clap; | Pat Pat Clap Pat; | March Right Left Right |
| | 1 2 3 Clap; | 1 2 3 Bend; | March Right Left Right | Left; |
| | 1 2 3 | 1 2 3 | Left; | Clap Pat Clap Star; |
| | Pause; | Pause; | Clap Clap Pat Right | Clap Right Stomp Clap |
| | (Pause 2 3 4); | (Pause 2 3 4); | Stomp; | Left Stomp; |
| | 1 2 3 Bend; | 1 2 3 Pat; | Clap Clap Pat Left | Clap Pat Clap Star; |
| | 1 2 3 Clap; | 1 2 3 Bend; | Stomp; | March Right Left Right |
| | 1 2 3 | 1 2 3 | Clap Clap Pat Clap; | Left; |
| | Pause; | Pause; | March Right Left Right | Right Stomp Clap Pat |
| | (Pause 2 3 4); | (Pause 2 3 4); | Left; | Star; |
| | | | Pat Pat Clap Right | Left Stomp Clap Pat Star; |
| | | | Stomp; | Clap Clap Pat Star; |
| | | | Pat Pat Clap Left Stomp; | March Right Left Right |
| | | | Pat Pat Clap Pat; | Left; |
| | | | March Right Left Right | |
| | | | Left; | |

where numbers indicate counting the beat without movement.

33. A method of generating integrated progressively complex visual sequences to strengthen cognition, the method comprising the following steps:
generating and projecting to a user, multiple levels of visual instructions corresponding to a series of progressively complex motor movements to be performed by the user, the instructions being presented in a predetermined developmental order;
increasing a complexity of the multiple levels of visual instructions over time by increasing cognitive processing and increasing sensory motor processing demands.

34. The method of claim 33, wherein the instructions begin with vertical sequences and patterns of movement.

35. The method of claim 33, wherein the movements begin with simple unilateral and bilateral movements.

36. The method of claim 33, wherein the movements include movements crossing a coronal, sagittal, or transverse body plane.

37. The method of claim 36, wherein movements crossing the coronal plane involve one or more coronal planar spatial zones, movements crossing the sagittal plane involve one or more sagittal planar spatial zones, and movements crossing the transverse plane involve one or more transverse planar spatial zones.

38. The method of claim 36, wherein the instructions begin with a low level of complexity involving crossing one body plane, and increase to a higher level of complexity involving crossing all three body planes.

39. The method of claim 33, wherein movements are indicated to be quarter note moves on the beat, eighth note moves with a double movement, half note movements held for two beats, or whole note movements held for four beats.

40. The method of claim 39, wherein in Level 1, one or more movements are on beat four, in Level 2, one or more movements are on beats two and four, in Level 3, one or more movements are on beats one and three, and in Level 4, one or more movements are on every beat.

41. The method of claim 39, wherein in Level 5, movements are on every beat and comprise eighth note, quarter note, or half note movements, in Level 6, movements include cross lateral movement in the dorsal coronal plane, in Level 7, movements include rhythmic forward and backward movements, and in Level 8, movements include gross motor movements traversing the sagittal and coronal planes.

42. The method of claim 39, wherein the instructions begin with quarter and eighth note movements and progress to half and whole note movements.

43. The method of claim 33, wherein the series of movements is divided into a plurality of portions, each portion of the series of movements being followed by an instruction for a period of deep breathing by the user.

44. The method of claim 33, wherein the visual instructions projected to the user include instructions for a current movement and instructions for a subsequent movement which follows the current movement, wherein instructions for the current and subsequent movements are conveyed using a cognitive motor visual code.

45. The method of claim 44, wherein the cognitive motor visual code includes symbols, colors, or graphics corresponding to each movement.

46. The method of claim 45, wherein a plurality of lines of the cognitive motor visual code are presented to the user simultaneously.

47. The method of claim 33, wherein a plurality of users complete the movements in a group setting, and a determination is made to move to a next level of sequences when a predetermined minimum percentage of the plurality of users is able to complete the movements correctly.

48. The method of claim 47, wherein the predetermined minimum percentage is at least 80%.

49. The method of claim 33, wherein a determination is made to move the user to a next level of sequences when a predetermined minimum percentage of the movements are completed correctly by the user.

50. The method of claim 49, wherein the predetermined minimum percentage is at least 80%.

51. The method of claim 33, wherein the movements include bend, clap, pause, stomp, march, pat, raise the roof, cross, star, twist, or climb the ladder.

52. A system for generating integrated progressively complex audiovisual sequences to strengthen cognition, comprising:
a processor;
a memory containing instructions which when executed by the processor cause the processor to:
generate and project to a user, multiple levels of audiovisual instructions corresponding to a series of progressively complex motor movements to be performed by the user, the instructions being presented in a predetermined developmental order;
increase a complexity of the multiple levels of audiovisual instructions over time by increasing cognitive processing and increasing sensory motor processing demands.

53. A system for generating integrated progressively complex audiovisual sequences to strengthen cognition, comprising:
a processor;
a memory containing instructions which when executed by the processor cause the processor to:
generate and project to a user, audiovisual instructions corresponding to a series of progressively complex motor movements to be performed by the user, the instructions being presented in a predetermined developmental order;
wherein the audio portion of the instructions includes music which is performed in 4/4 time;
said instructions including a plurality of levels, each level having a plurality of options which may be selected for that particular level;
each level including a priming portion of a first plurality of beats, followed by a first new move introduction of a second plurality of beats, followed by a practice period of the first new move of a third plurality of beats, followed by a first cognitive movement break for a fourth plurality of beats, followed by a second new move of a fifth plurality of beats, a practice period of the second new move of a sixth plurality of beats, followed by a second cognitive movement break for a seventh plurality of beats, followed by at least one performance period of an eighth plurality of beats combining the first new move and the second new move.

54. A system for generating integrated progressively complex visual sequences to strengthen cognition, comprising:
a processor;
a memory containing instructions which when executed by the processor cause the processor to:
generate and project to a user, multiple levels of audiovisual instructions corresponding to a series of progressively complex motor movements to be performed by the user, the instructions being presented in a predetermined developmental order;
increase a complexity of the multiple levels of audiovisual instructions over time by increasing cognitive processing and increasing sensory motor processing demands.
